(19) United States
(12) Patent Application Publication
(10) Pub. No.: US 2023/0177540 A1
(43) Pub. Date: Jun. 8, 2023

(54) QUESTIONNAIRE CORRECTION PROGRAM, METHOD PERFORMED BY COMPUTER TO CORRECT QUESTIONNAIRE RESULT, AND QUESTIONNAIRE COUNT DEVICE

(71) Applicant: Konica Minolta, Inc., Tokyo (JP)

(72) Inventor: JUNICHI FURUKAWA, Tokyo (JP)

(21) Appl. No.: 17/986,468

(22) Filed: Nov. 14, 2022

(30) Foreign Application Priority Data
Dec. 2, 2021 (JP) 2021-196009

(51) Int. Cl. G06Q 30/02

(52) U.S. Cl. CPC G06Q 30/0203

(57) ABSTRACT

A non-transitory recording medium storing a computer readable questionnaire correction program causes a computer to perform: accessing each of answer results in which an answer to each of a plurality of questions constituting a questionnaire is selected from a plurality of choices of a plurality of numerical values; calculating a variation in the answer results; and correcting each of the answer results on a basis of the variation calculated.

The entire disclosure of Japanese patent Application No. 2021-196009, filed on Dec. 2, 2021, is incorporated herein by reference in its entirety.

### BACKGROUND

### Technological Field

The present disclosure relates to information processing, and more specifically, to a technique of correcting the bias of answers of questionnaire results.

### Description of the Related Art

The answer format of questionnaires and other questions includes a free answer format and an answer choice format. For example, there are a person who selects and answers an extreme number (1 or 10) and a person who selects and answers an average number (5 or 6) to a question of selecting an answer from an answer field including 1 to 10 choices in the answer choice format. As described above, there is a problem that the answer result is affected by the personality and psychological factors of a respondent.

In addition, in a case where the same respondent regularly answers the same questionnaire, there are a case where the respondent answers with an extreme number and a case where the respondent answers with an average number depending on a psychological situation at the time of answer. There is a problem that answer results vary even in the same respondent when the times are different, and the objectivity of the questionnaire is lowered. Therefore, there is a need for a method capable of excluding personality and psychological factors of the respondent of the questionnaire and accurately evaluating the questionnaire

Regarding a questionnaire evaluation method, for example, JP 2004-287736 A discloses a technique of proposing “calculating a pattern indicating a psychological tendency of a respondent on the basis of answer results of a question group and a dummy question group obtained from the respondent to calculate a coefficient, correcting the answer results using the coefficient and proposing the answer results, and obtaining objective questionnaire results reflecting the psychological tendency of the respondent”. This technique is a technique of “providing an answer result table for collecting answer results of a question and a dummy question of a questionnaire, calculating a pattern indicating a psychological tendency on the basis of one or both of the answer result of the question and the answer result of the dummy question in the answer result table, and calculating a coefficient corresponding to the pattern and correcting the answer result” (see [Abstract of the Disclosure]).

However, according to the technique disclosed in JP 2004-287736 A, it is difficult to determine the psychological error tendency of a respondent from one dummy question, and the number of questions increases if a plurality of dummy questions is inserted, and thus the burden for the respondent to answer increases. In addition, in the technique, since the method of calculating a correction coefficient is different for each of three patterns of a lenient tendency, a central tendency, and a comparison bias tendency, the pattern needs to be recognized before the calculation. Furthermore, the technique cannot correct tendencies other than three patterns.

In addition, the technique includes the past answer results in the formula for calculating the correction coefficient of each of the lenient tendency and the central tendency. The comparison bias tendency is on condition that the answer result of the dummy question of the respondent falls within the range of the past answer results. Therefore, the technique cannot calculate the correction coefficient of each of the lenient tendency, the central tendency, and the comparison bias tendency without the past answer results.

Therefore, there is a need for a technique of obtaining a highly objective answer result of a questionnaire without increasing the burden on the respondent. In addition, there is a need for a technique capable of correcting variations in answer results without depending on a specific pattern. Furthermore, there is a need for a technique capable of correcting variations in answer results without requiring past answer results.

### SUMMARY

The present disclosure has been made in view of the background described above, and an object of one aspect is to provide a technique of extracting a highly objective answer result of a questionnaire without increasing a burden on a respondent of the questionnaire. An object of another aspect is to provide a technique capable of correcting variations in answer results without depending on a specific pattern. Furthermore, another object of the present disclosure is to provide a technique capable of correcting variations in answer results without requiring past results.

To achieve at least one of the abovementioned objects, according to an aspect of the present invention, there is provided a non-transitory recording medium storing a computer readable questionnaire correction program, and the program reflecting one aspect of the present invention causes a computer to perform: accessing each of answer results in which an answer to each of a plurality of questions constituting a questionnaire is selected from a plurality of choices of a plurality of numerical values; calculating a variation in the answer results; and correcting each of the answer results on a basis of the variation calculated.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a system that counts a questionnaire performed online in accordance with one aspect;

FIG. 2 is a block diagram illustrating a hardware configuration of a computer system that implements a terminal or a questionnaire count device;

FIGS. 3A to 3C are diagrams illustrating the transition of a screen displayed on a monitor of the terminal;

FIG. 4 is a diagram illustrating a specific example of a questionnaire having five-level answers as choices;

FIG. 5 is a diagram illustrating a specific example of a questionnaire having ten-level answers as choices;

FIG. 6 is a diagram illustrating a specific example of a questionnaire having ten-level answers as choices;

FIG. 7 is a diagram illustrating an aspect of storing questionnaire results in a hard disk included in the questionnaire count device;

FIG. 8 is a diagram illustrating an aspect of storing each of answer results in the hard disk in a case where the same questionnaire is performed a plurality of times in another aspect;

FIGS. 9A and 9B are diagrams illustrating answer results before and after the correction according to the present embodiment is applied to the individual answers;

FIG. 10 is a flowchart illustrating a part of processing performed by a CPU of the computer system functioning as the questionnaire count device;

FIG. 11 is a diagram illustrating a state where data before and after correction of five-level answer choices is stored in the hard disk;

FIGS. 12A and 12B are diagrams illustrating an example of correction of results of one respondent in the questionnaire having five-level answer choices;

FIGS. 13A and 13B are diagrams illustrating a procedure of correcting a numerical value of an answer in consideration of the degree of deviation of a choice selected as the answer of the respondent from an average value;

FIGS. 14A and 14B are diagrams illustrating a procedure of correcting a difference between an average value of answers of the respondent (Suzuki) and a median of an answer field;

FIGS. 15A and 15B are diagrams illustrating a procedure of correcting a difference between an average value of answers of the respondent (Sato) and a median of an answer field;

FIGS. 16A and 16B are diagrams illustrating a procedure of correcting a difference between an average value of answers of the respondent (Takahashi) and a median of an answer field;

FIGS. 17A and 17B are diagrams illustrating a procedure of correcting a difference between an average value of answers of the respondent (Tanaka) and a median of an answer field; and

FIG. 18 is a diagram illustrating a screen of a questionnaire in which the number of choices varies depending on a question.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference numerals. This holds true for names and functions. Therefore, detailed descriptions thereof will not be repeated.

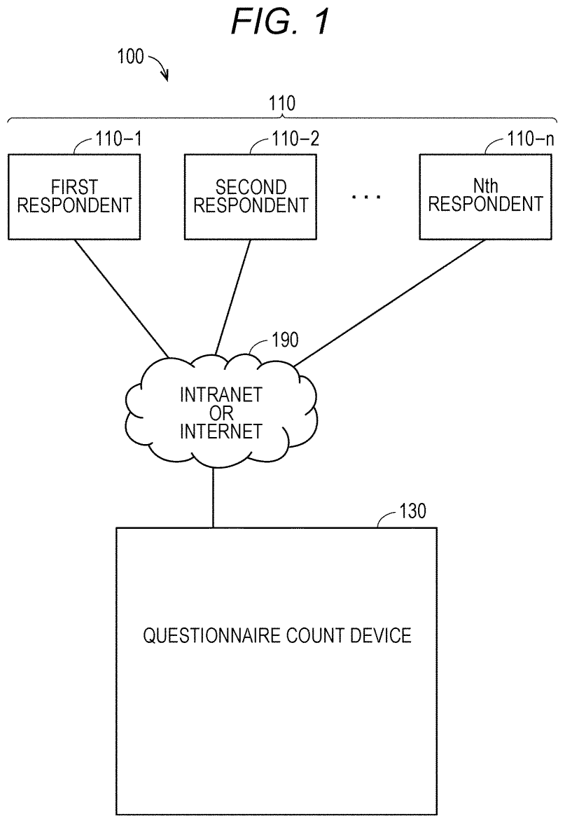

An aspect of counting a questionnaire will be described with reference to FIG. 1. FIG. 1 is a diagram illustrating an example of a system 100 that counts a questionnaire performed online in accordance with one aspect. The system 100 includes terminals 110-1, 110-2, and 110-n used respectively by a first respondent to an n-th respondent, and a questionnaire count device 130. The terminals 110-1, 110-2, and 110-n and the questionnaire count device 130 are communicably connected to each other by a network 190 implemented as an intranet or the Internet. The terminals 110-1, 110-2, and 110-n are collectively referred to as a terminal 110.

In one aspect, the questionnaire count device 130 displays a questionnaire on each terminal 110. Each of the respondents inputs answers to the questionnaire from the terminal 110 that can be used by each of the respondents. The questionnaire count device 130 counts the individual answers, displays a count result, or outputs the count result to another information processing device.

In another aspect, a plurality of respondents may answer the questionnaire using one terminal 110. In this case, for example, by individually logging in to the account held by each of the respondents and answering the questionnaire presented in the account, a plurality of respondents can answer the questionnaire while sharing one terminal 110.

[Configuration of Computer System]

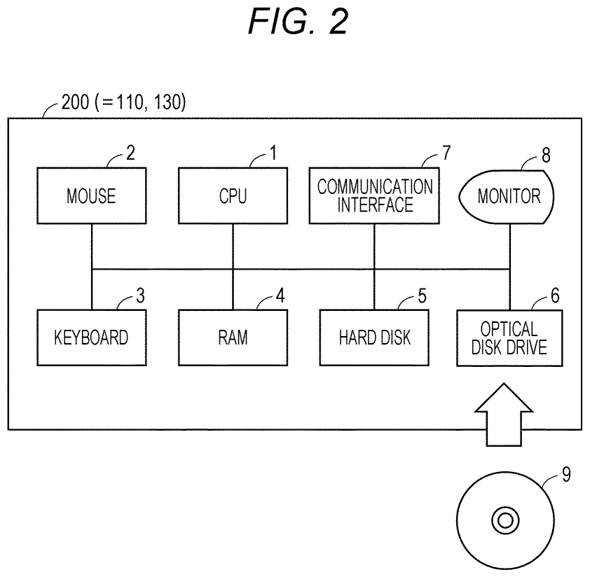

A configuration of an information processing device constituting the system 100 will be described with reference to FIG. 2. FIG. 2 is a block diagram illustrating a hardware configuration of a computer system 200 that implements the terminal 110 or the questionnaire count device 130.

The computer system 200 includes, as main components, a central processing unit (CPU) 1 that executes a program, a mouse 2 and a keyboard 3 that receive an input of an instruction from a user of the computer system 200, a RAM 4 that stores data generated by the execution of the program by the CPU 1 or data input via the mouse 2 or the keyboard 3 in a volatile manner, a hard disk 5 that stores data in a nonvolatile manner, an optical disk drive 6, a communication interface (I/F) 7, and a monitor 8. The components are connected to each other by a data bus. A compact disc-read only memory (CD-ROM) 9 or another optical disk can be mounted on the optical disk drive 6.

The processing in the computer system 200 is implemented by each piece of hardware and software performed by the CPU 1. Such software may be stored in advance in the hard disk 5. The software may be stored in the CD-ROM 9 or another recording medium and distributed as a computer program. Alternatively, the software may be provided as an application program that can be downloaded by an information provider connected to a so-called Internet. Such software is read from the recording medium by the optical disk drive 6 or another reading device, or is downloaded via the communication interface 7, and then is once stored in the hard disk 5. The software is read from the hard disk 5 by the CPU 1 and stored in the RAM 4 in the form of an executable program. The CPU 1 executes the program.

The individual components constituting the computer system 200 illustrated in FIG. 2 are general components. Therefore, it can be said that one of essential parts of the technical idea according to the present disclosure is software stored in the RAM 4, the hard disk 5, the CD-ROM 9 or another recording medium, or software that can be downloaded via a network. The data recording medium can include a non-transitory computer-readable data recording medium. Since the operation of each piece of hardware of the computer system 200 is well known, detailed description will not be repeated.

Note that the recording medium is not limited to a CD-ROM, a flexible disk (FD), or a hard disk, and may be a medium that fixedly carries a program, such as a solid state drive (SSD), a magnetic tape, an optical disk (Magnetic Optical Disc (MO)/Mini Disc (MD)/Digital Versatile Disc (DVD)), an integrated circuit (IC) card (including a memory card), an optical card, a semiconductor memory such as a mask ROM, an electronically programmable read-only memory (EPROM), an electronically erasable programmable read only memory (EEPROM), or a flash ROM.

The program referred to herein includes not only a program directly executable by the CPU but also a program in a source program format, a compressed program, an encrypted program, and the like.

The computer system 200 can be implemented as a notebook computer device, a desktop computer device, or other computer devices, or a portable information communication terminal such as a smartphone or a tablet terminal.

[Display Example of Screen]

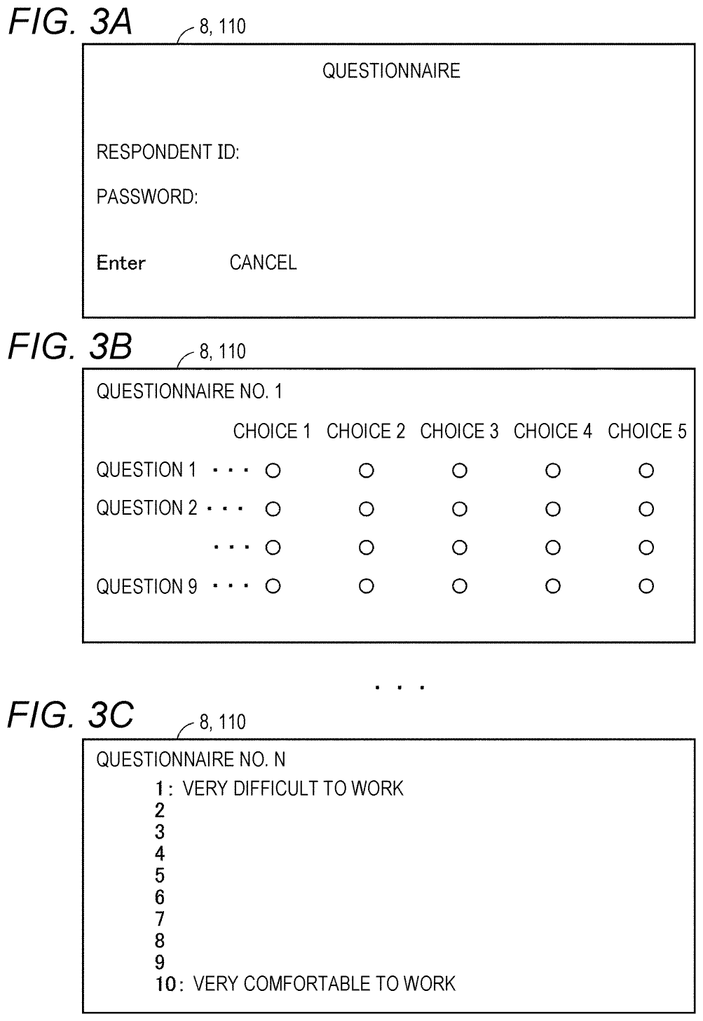

An example of a screen displayed on the terminal 110 will be described with reference to FIGS. 3A to 6. The terminal 110 displays one or more questionnaires on the monitor 8 on the basis of the data received from the questionnaire count device 130.

FIGS. 3A to 3C are diagrams illustrating the transition of a screen displayed on the monitor 8 of the terminal 110.

As shown in a screen of FIG. 3A, the monitor 8 displays a login screen of a respondent of a questionnaire When a certain respondent inputs an assigned respondent identification (ID) and a password, the login screen is switched to a specific questionnaire screen.

Specifically, as shown in a screen of FIG. 3B, the monitor 8 displays a first question of the questionnaire The questionnaire has, for example, a form in which an answer to a certain question is selected from a plurality of choices, for example, five choices. Note that the number of choices is not limited to five.

For example, in another aspect, as shown in a screen of FIG. 3C, the monitor 8 can display, as an example of another questionnaire, a questionnaire having ten-level choices as answer choices.

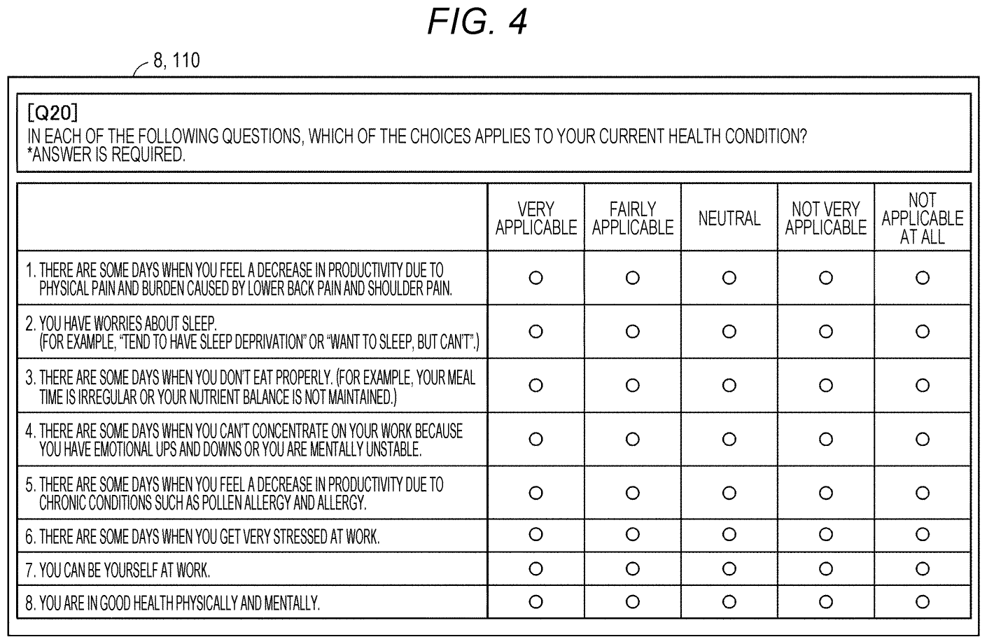

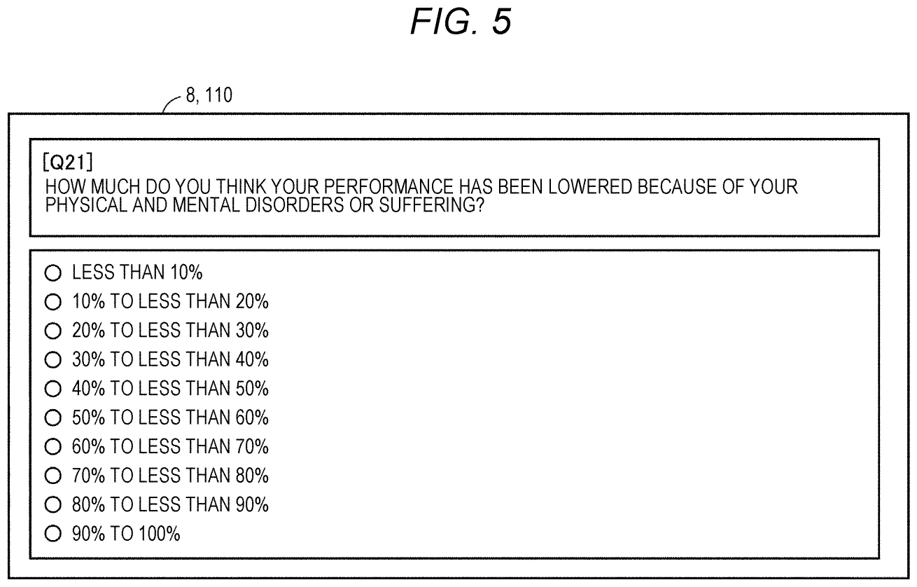

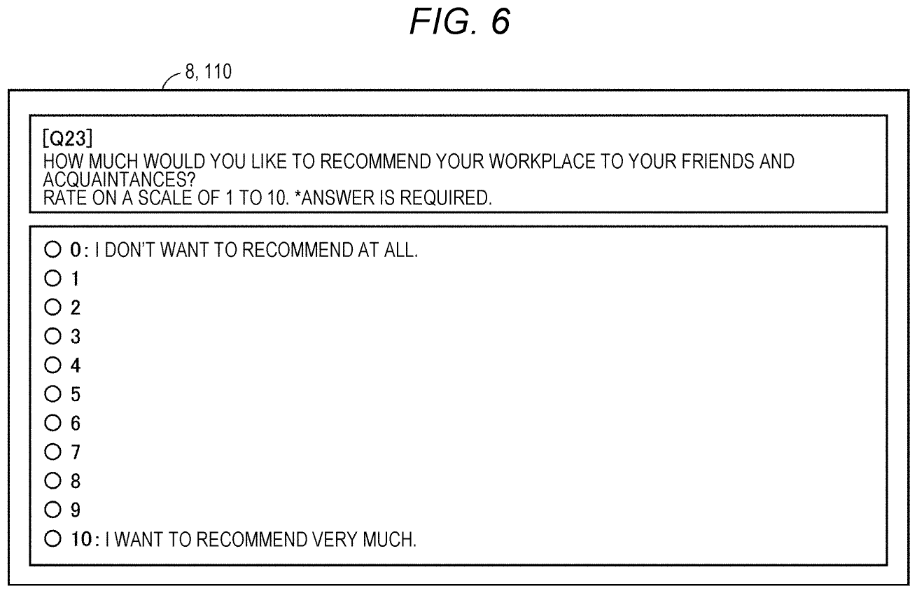

FIG. 4 is a diagram illustrating a specific example of a questionnaire including answers in which the Likert scale is adopted for choices. FIGS. 5 and 6 are diagrams each illustrating a specific example of a questionnaire having ten-level answers as choices. The respondent selects an answer to each question from choices, and when the respondent answers at least all the questions displayed that the answer is required, the questionnaire ends. In another aspect, another questionnaire other than the questionnaire can be displayed.

Note that, instead of another aspect, the screen of FIG. 3A does not need to be displayed on the terminal 110. For example, in a questionnaire in which the target of respondents is not limited, any terminal 110 may receive answers to the questionnaire. In this case, the identification information of the terminal 110 used to answer the questionnaire may or may not be transmitted to the questionnaire count device 130.

[Data Structure of Questionnaire Count Device 130]

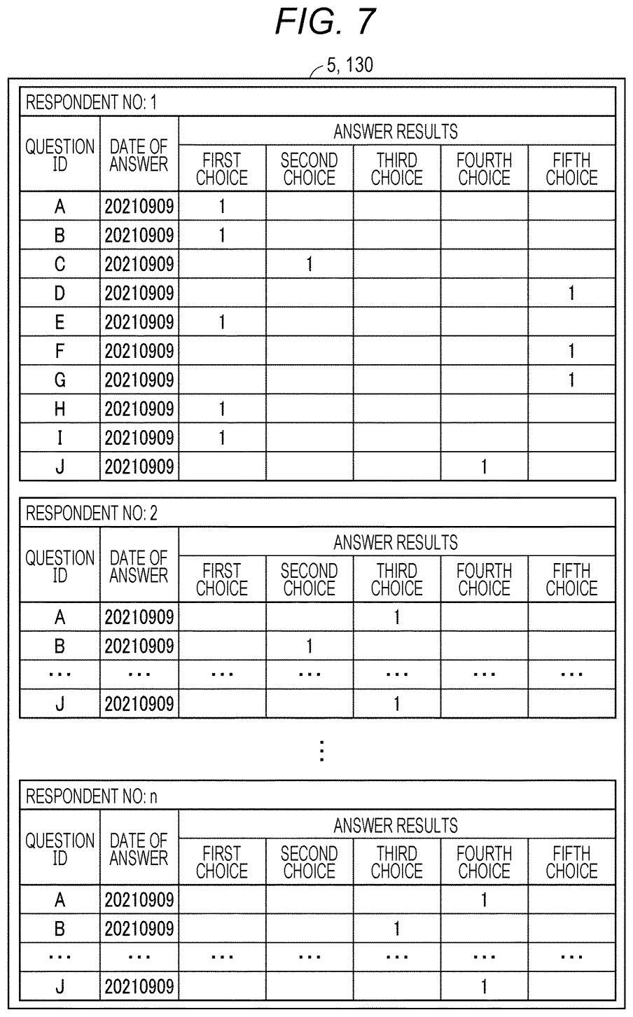

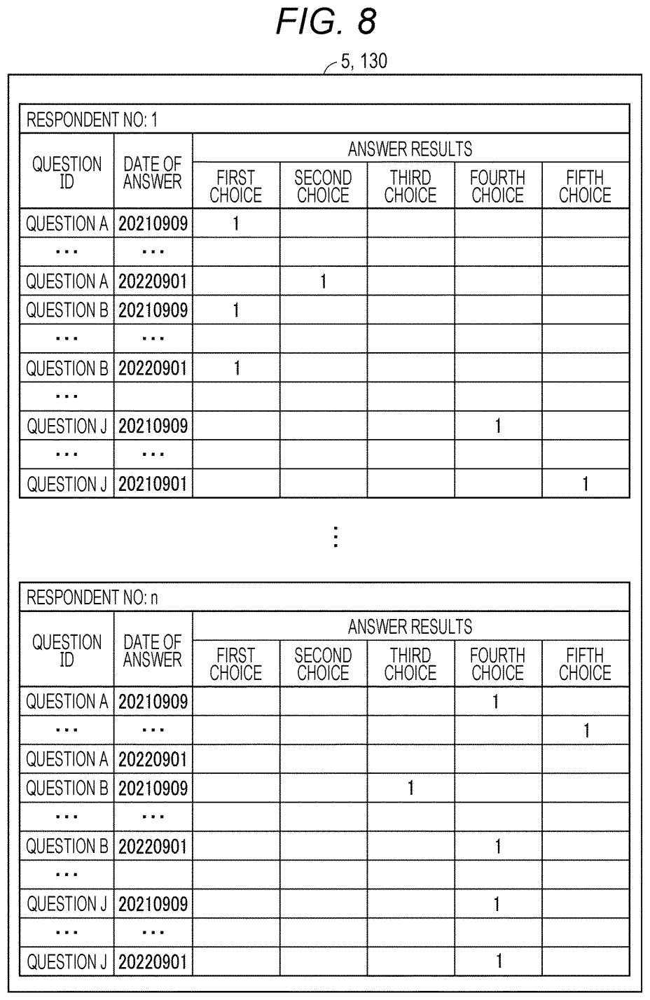

The data structure of the questionnaire count device 130 will be described with reference to FIGS. 7 and 8. In one aspect, a questionnaire is performed only once, and answers at that time are held in the questionnaire count device 130. In another aspect, the questionnaire can be periodically performed, and the individual answers can be held in the questionnaire count device 130.

FIG. 7 is a diagram illustrating an aspect of storing questionnaire results in the hard disk 5 included in the questionnaire count device 130. The hard disk 5 holds the answer results of the individual respondents in a state where the respondents are not specified in each questionnaire. The example of FIG. 7 shows answers to ten questions from A to J each of which includes five choices. That is, the choice selected as the answer by the respondent is flagged as “1”. The hard disk 5 also records the date and time when each question was answered. The questionnaire count device 130 counts the questionnaire results using these answers and compares the current answer result with the previous answer result, thereby being capable of analyzing the tendency of the respondent.

In the example of FIG. 7, the respondent with a respondent number 1 selects a first choice or a fifth choice as an answer to a question. Therefore, this respondent can be determined to tend to choose an extreme answer as compared to other respondents.

On the other hand, the respondent with a respondent number 2 or n selects second to fourth choices as an answer to a question. Therefore, this respondent can be determined to tend to avoid an extreme answer as compared to other respondents.

FIG. 8 is a diagram illustrating an aspect of storing each of answer results in the hard disk 5 in a case where the same questionnaire is performed a plurality of times in another aspect. In this case, since the hard disk 5 holds the answer result associated with the date and time of answer for each respondent, it is possible to verify the change in the answer of each respondent.

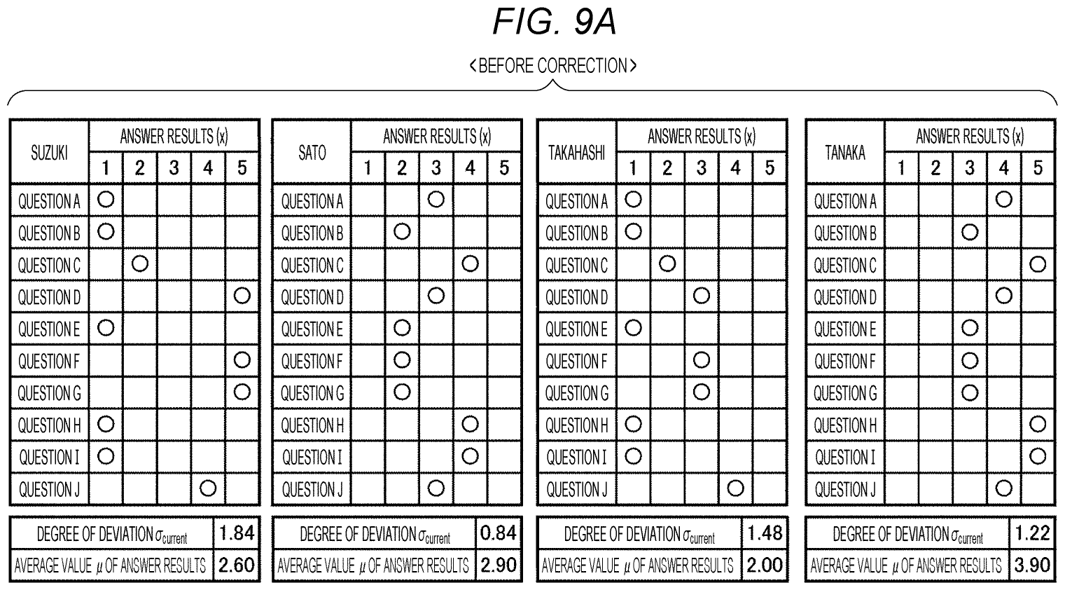

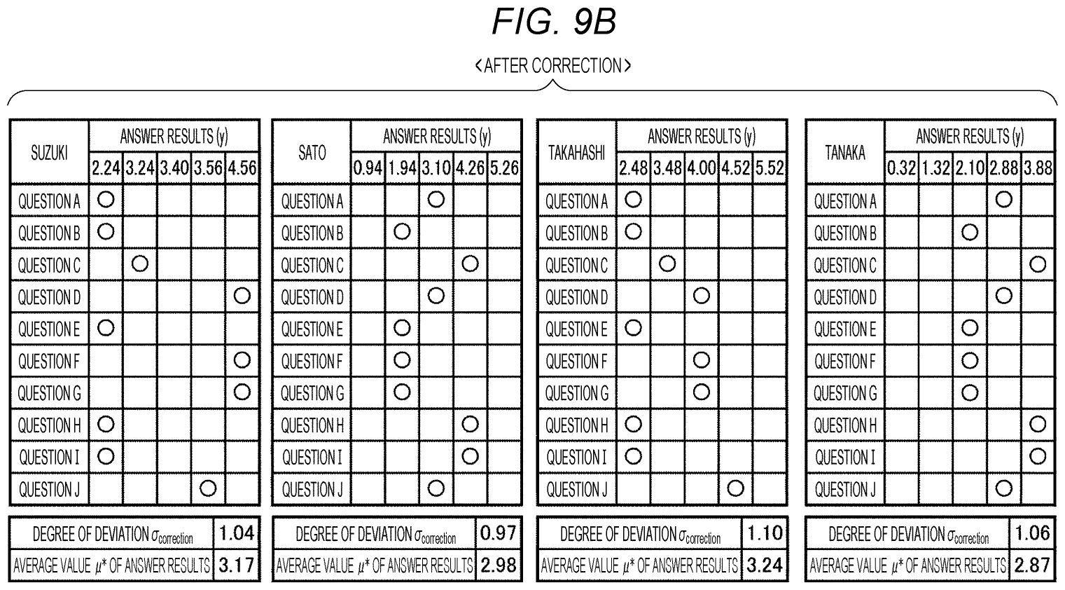

FIGS. 9A and 9B are diagrams illustrating answer results before and after the correction according to the present embodiment is applied to the individual answers. In FIGS. 9A and 9B, o attached to each question indicates that the choice has been selected among choices 1 to 5. For example, in the case of “Suzuki”, since o is attached to an answer result “1” to a question A, a choice “1” is selected as the answer. Hereinafter, a case where a target value (σ_{goal}) of the degree of deviation is 1 will be described. The target value (σ_{goal}) can be set by being input to the questionnaire count device 130 by a user of the questionnaire count device 130, a questionnaire implementer, or the like.

In the example of FIGS. 9A and 9B, as the answer result before correction, the degree of deviation (σ_{current}) is “1.84” in the case of “Suzuki”. The average value (μ) of the answer results is “2.60”.

When the answer results are corrected, the values (1, 2, 3, 4, and 5) of the answer results before correction are respectively corrected to values (2.24, 3.24, 3.40, 3.56, and 4.56). The degree of deviation (σ_{correction}) of the corrected answer result is “1.04”. The average value (μ*) of the answer results is “3.17”.

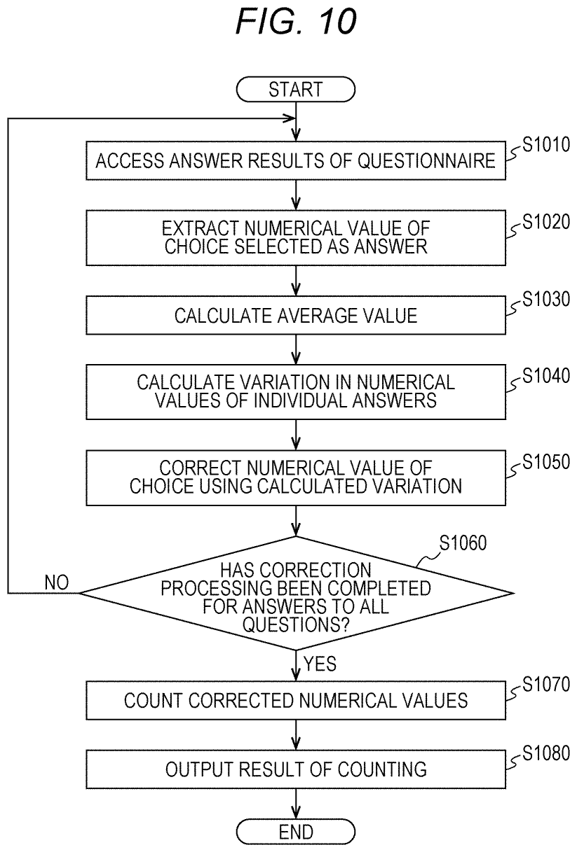

The control structure of the questionnaire count device 130 will be described with reference to FIG. 10. FIG. 10 is a flowchart illustrating a part of processing performed by the CPU 1 of the computer system 200 functioning as the questionnaire count device 130.

In step S1010, the CPU 1 accesses answers to a questionnaire. For example, the CPU 1 accesses a database of the answers to the questionnaire (FIG. 7 or FIG. 8) when detecting an instruction to count the questionnaire or when detecting arrival of a predetermined counting time.

In step S1020, the CPU 1 extracts a numerical value of a choice selected as the answer. For example, in a case where the answer is in five levels of 1 to 5, the numerical value of the choice is any of 1, 2, 3, 4, or 5. In a case where the answer is in ten levels of 1 to 10, the numerical value of the choice is any of 1, 2, 3, 4, 5, 6, 7, 8, 9, or 10.

In step S1030, the CPU 1 calculates an average value of numerical values of the choices of the individual answers.

In step S1040, the CPU 1 calculates a variation in the values of the individual answers (also referred to as “degree of deviation”). Details of the calculation of the degree of deviation will be described later.

In step S1050, the CPU 1 corrects the numerical value of the choice selected as the answer using the calculated variation.

In step S1060, the CPU 1 determines whether or not the correction processing has been completed for all the questions in the questionnaire. If it is determined that the correction processing has been completed for all the questions (YES in step S1060), the CPU 1 switches the control to step S1070. Otherwise (NO in step S1060), the CPU 1 returns the control to step S1010.

In step S1070, the CPU 1 counts the corrected numerical values.

In step S1080, the CPU 1 outputs the result of counting. For example, the CPU 1 displays the result on the monitor 8 of the questionnaire count device 130. Alternatively, the CPU 1 can convert the result into a predetermined data format and transmit the data format to another information processing device.

[Comparison of Degree of Deviation Before and After Correction]

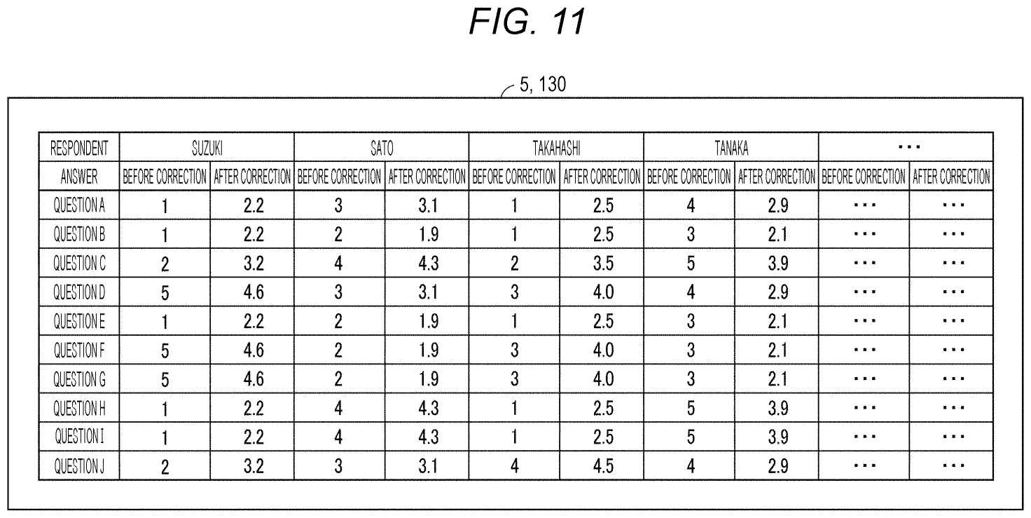

The data structure before and after the correction by the questionnaire count device 130 will be described with reference to FIG. 11. FIG. 11 is a diagram illustrating a state where data before and after correction of five-level answer choices is stored in the hard disk 5. This data corresponds to the correction of the answer content illustrated in FIGS. 9A and 9B.

<Comparison of Variations (Degree of Deviation) Before and After Correction of Answer Result>

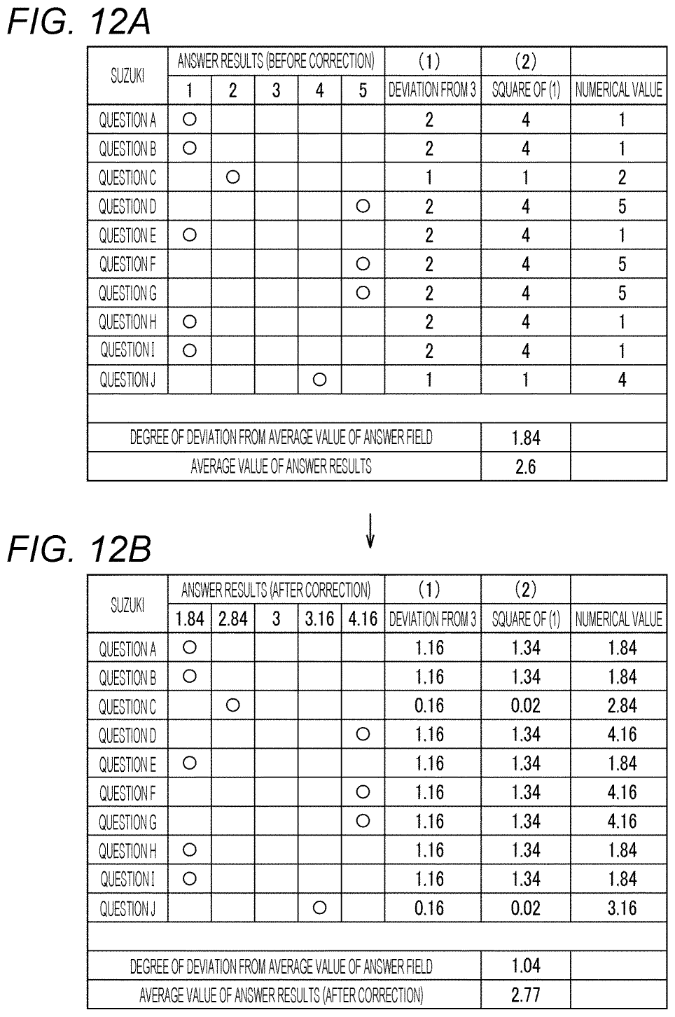

The calculation of the degree of deviation in the present embodiment will be described with reference to FIGS. 12A and 12B. FIGS. 12A and 12B are diagrams illustrating an example of correction of results of one respondent in a questionnaire having five-level answer choices.

[Before Correction of Answer Result]

The state in FIG. 12A shows each piece of data in a state before correction of the answer results of the questionnaire Since the simple average value of five answer choices (1, 2, 3, 4, and 5) is “3”, the CPU 1 calculates the difference between the numerical value of a choice selected as the answer to each question and the simple average value (see column of “deviation from 3”). Furthermore, the CPU 1 calculates the square of the difference. The CPU 1 sums the calculated values of squares (total value=34), and calculates a simple average value 3.4 (=34÷10) of the total value on the basis of the number of questions (=10). The CPU 1 calculates a square root 1.84 (=√3.4) of the simple average value as a variation (degree of deviation).

That is, the CPU 1 calculates the degree of deviation (σ_{current}) using Formula (1).

$$\begin{matrix}[ Mathematical Formula 1 ] & \\ {σ}_{curent} = \sqrt{\frac{1}{n} {\sum }_{i = 1}^{n} {( {x}_{i} - \overline{x} )}^{2}} & ( 1 )\end{matrix}$$

n denotes number of questions.
x denotes answer result.
x̅ denotes average value of answer field.

In the example of FIGS. 12A and 12B, n=10. The answer result (the numerical value of the choice selected as the answer to the question) can be any of 1 to 5. The average value of the answer field indicates the average value of numerical values of choices prepared in advance. In the example of FIGS. 12A and 12B, the average value =2.6(=(1+1+2+5+1+5+5+1+1+4)/10=2.6).

[After Correction of Answer Result]

The state in FIG. 12B is a diagram showing the degree of deviation and an average value calculated after the answer values are corrected. The CPU 1 corrects the numerical values of the choices selected by the respondent using the degree of deviation (=1.84) calculated in the state in FIG. 12A.

Specifically, the CPU 1 corrects the numerical value of the choice selected as the answer using an arithmetic expression “numerical value of answer to each question+(degree of deviation−target value of degree of deviation)”. Here, it is assumed that the target value of the degree of deviation is 1, and the degree of deviation from the average value of the answer field is 1.84.

For example, the numerical value (=1) of the choice selected as the answer of Suzuki to the question A becomes 1+(1.84-1)=1.84 from the arithmetic expression. Therefore, the numerical value in the answer field is corrected from “1” before the correction to “1.84”. The same applies to the numerical values (2 to 5) of other questions and other answer fields. As a result, the numerical values (1, 2, 3, 4, and 5) of the choices for Suzuki are respectively corrected to numerical values (1.84, 2.84, 3.00, 3.16, and 4.16). The average value of the numerical values of the individual choices in the corrected answer field is 2.77 (=(1.84+1.84+2.84+4.16+1.84+4.16+4.16+1.84+1.84+3.16/10)).

Furthermore, the CPU 1 calculates the degree of deviation using Formula (1) to obtain the degree of deviation (=1.04).

For other respondents, the values in the answer field are corrected on the basis of the arithmetic expression described above, and the degree of deviation can be derived.

<Degree of Deviation from Average Value of Answers>

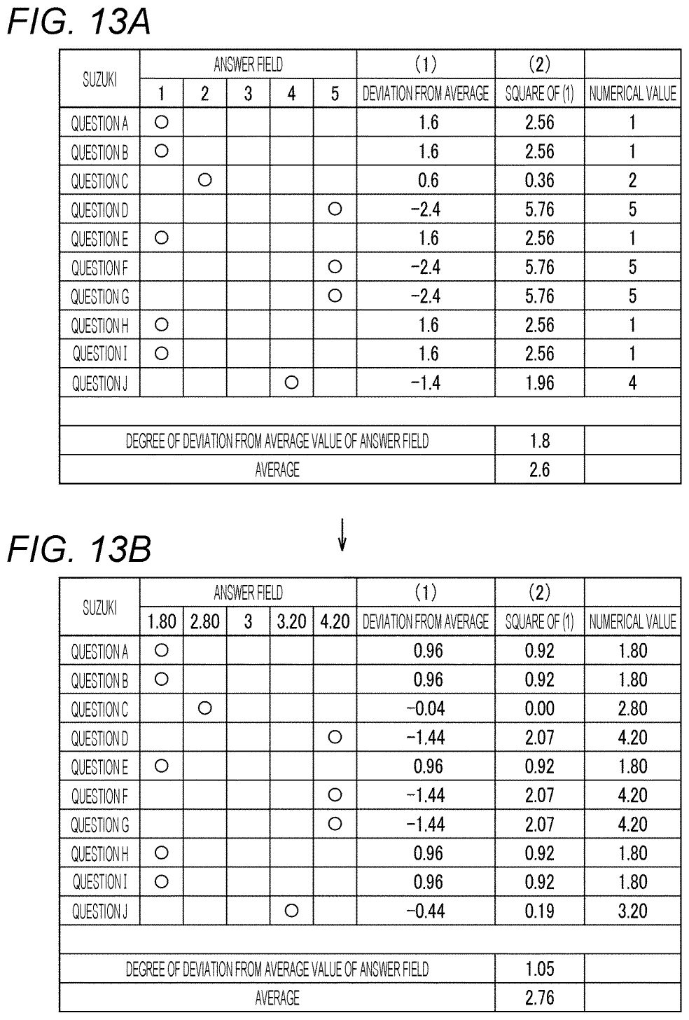

Another method will be described with reference to FIGS. 13A and 13B. FIGS. 13A and 13B are diagrams illustrating a procedure of correcting a numerical value of an answer in consideration of the degree of deviation of a choice selected as the answer of a respondent from an average value.

[Before Correction of Answer Result]

The state in FIG. 13A is a diagram illustrating an example of deriving the degree of deviation of a numerical value of a choice selected as an answer from an average value before the numerical value is corrected. The content described in an answer field is the same as the content described in the answer field of the state in FIG. 12A.

The simple average value of the numerical values of the choices selected by the respondent is “2.6”. Therefore, the CPU 1 calculates the difference between the choice and the simple average value as “deviation from average” for each of ten questions (see column (1)). The CPU 1 calculates a value by squaring the calculated value (see column (2)). Furthermore, the CPU 1 calculates the square root (1.80) of the average value of the values obtained by squaring as the degree of deviation of the answers by the respondent from the average value.

[After Correction of Answer Result]

The state in FIG. 13B is a diagram showing a state where numerical values of choices are corrected. Among the numerical values of five choices, the numerical values other than the middle choice are corrected by an arithmetic expression “corrected numerical value=numerical value of choice before correction−(degree of deviation (1.80)−1)” using the calculated degree of deviation (1.80). For example, the numerical value (1) of the first choice becomes 1.80 (=1−(1.80−1)), and the numerical value (5) of the fifth choice becomes 4.20 (=5−(1.80−1)).

The CPU 1 calculates a simple average value 2.76 (=(1.80+1.80+2.80+4.20+1.80+4.20+4.20+1.80+1.80+3.20)/10) of ten answers using the corrected numerical values as the numerical values of the choices obtained by the respondent (Suzuki). The CPU 1 calculates the difference (the deviation) between the answer and the arithmetic mean value (2.76) for the answer to each question (column (1)). The CPU 1 calculates each of the square values of the differences (column (2)). Furthermore, the CPU 1 calculates the square root (=1.05) of the average value of the square values as the degree of deviation from the average value of the respondent.

For other respondents, the values in the answer field are corrected on the basis of the arithmetic expression described above, and the degree of deviation can be derived.

<Correction of Difference Between Average Value of Respondent and Median Value of Answer Field>

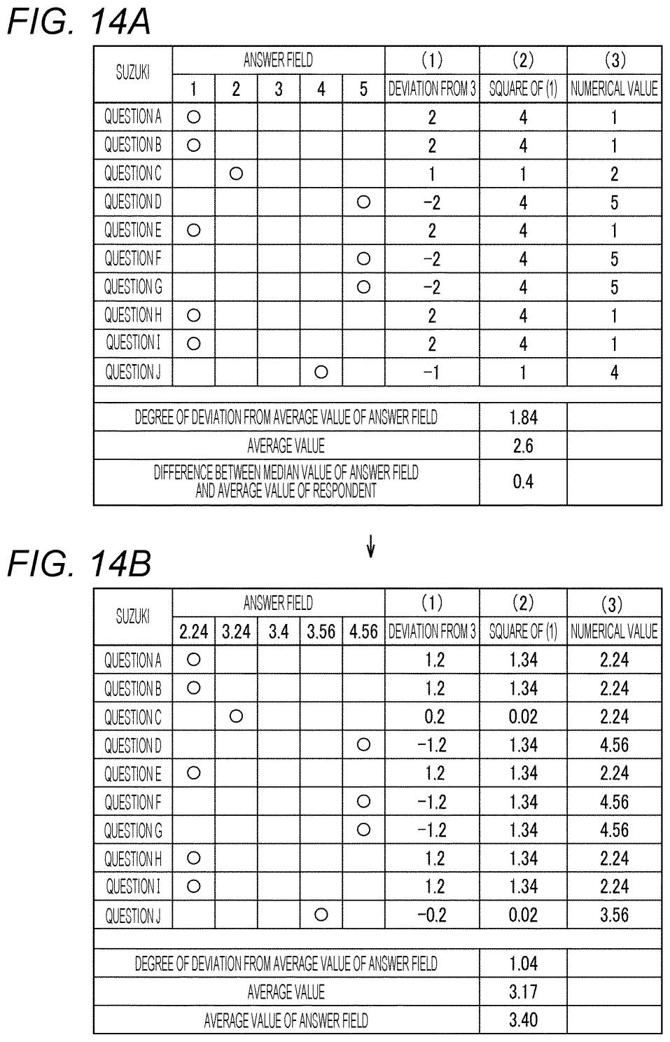

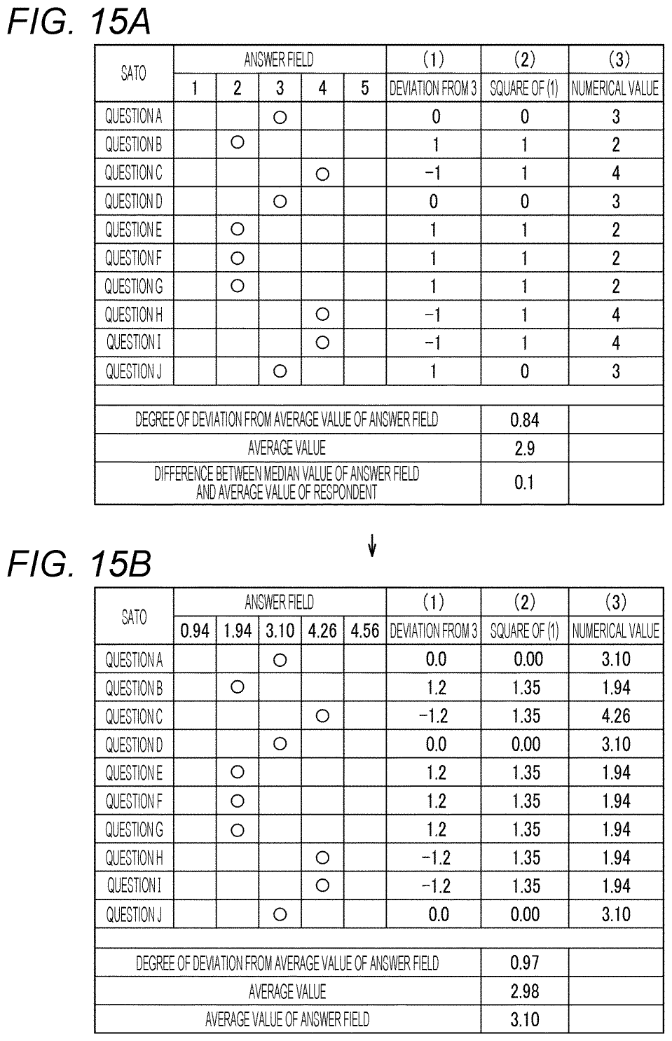

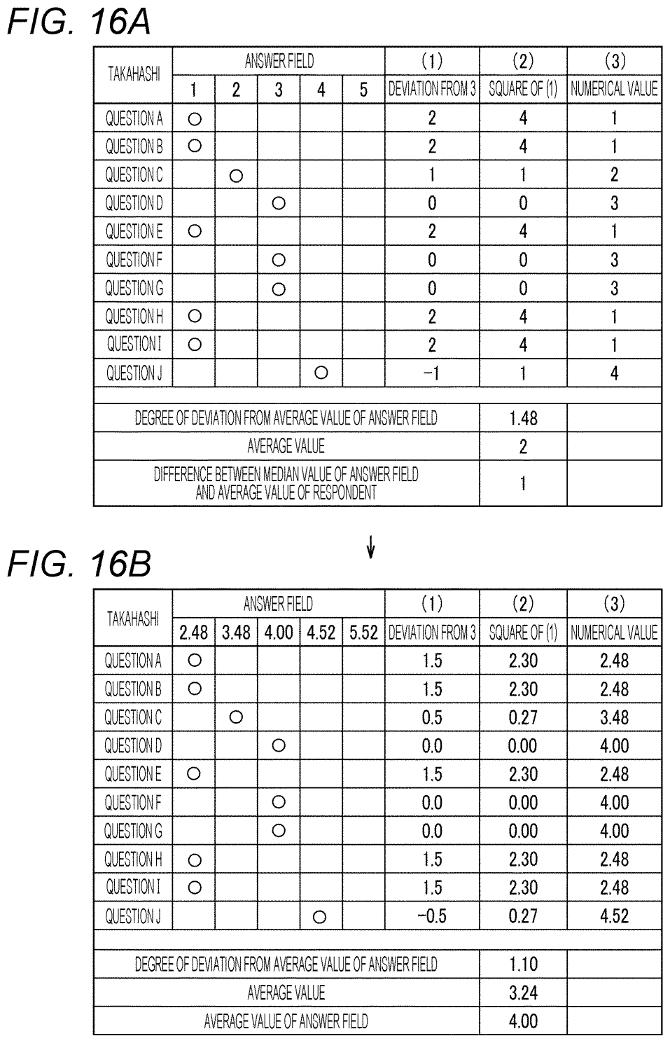

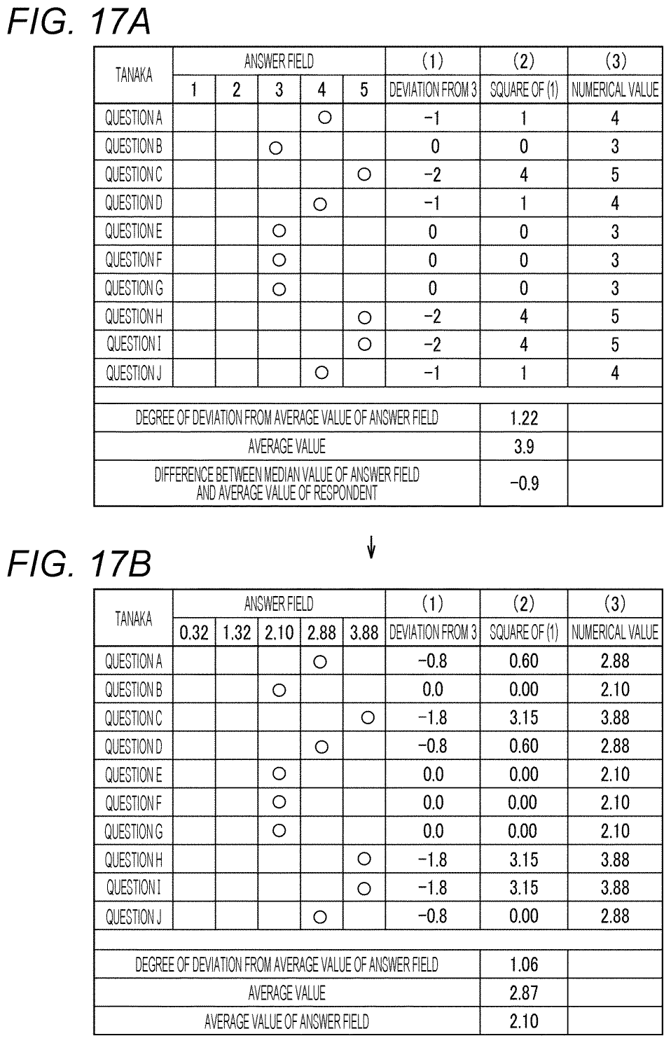

Another method will be described with reference to FIGS. 14A to 17B. FIGS. 14A to 17B are each a diagram illustrating a procedure of correcting the difference between an average value of answers of each of four respondents and a median value of an answer field.

[Before Correction of Answer Result]

Referring to FIGS. 14A and 14B, the state in FIG. 14A is a diagram illustrating an example of deriving the degree of deviation of a numerical value of a choice selected as an answer from an average value before the numerical value is corrected. The content described in an answer field is the same as the content described in the answer field of the state in FIG. 12A. The column (3) holds numerical values of choices selected by a respondent (Suzuki) for ten questions A to J.

For each answer, the CPU 1 calculates the difference (the deviation) between the value of the choice selected as the answer and the median value (the value of the third choice (=3)) of the answer field (see “deviation from 3” in column (1)). In this case, the difference S between the median value (=3) of the answer field and the average value (=2.6) of the respondent is 0.4.

The CPU 1 calculates the square value of the difference (see “square of (1)” in column (2)). Furthermore, the CPU 1 calculates the square root of the average value of the square values, and derives the degree of deviation (=1.843909) from the average value of the answer field.

[After Correction of Answer Result]

The state in FIG. 14B is a diagram showing a state where numerical values of choices are corrected. The first choice (numerical value=1) to the fifth choice (numerical value=5) are corrected using Formulas (2) to (5).

[Mathematical Formula 2]

δ=\ddot{x}−μ (2)

δ denotes difference between median value of answer field and average value of respondent.
x̅ denotes average value of answer field (average value of numerical values of choices prepared in advance).
μ denotes answer average value of respondent.

The CPU 1 selects one of Expressions (3) to (5) in accordance with the magnitude relationship between the answer result (the numerical value of the choice selected by the respondent) and the average value (=3) of the answer field.

[Mathematical Formula 3]

In case of x>x̅

yᵢ=xᵢ+(σ_{current}−σ_{goal})+δ (3)

[Mathematical Formula 4]

In case of x=x̅

yᵢ=xᵢ+δ (4)

[Mathematical Formula 5]

In case of x<x̅

yᵢ=xᵢ+(σ_{current}−σ_{goal})+6 (5)

[Calculation Example]

The CPU 1 corrects the numerical values of the individual choices as follows. First, the CPU 1 calculates the difference S using Formula (2).

Difference δ=3−2.6=0.4

In the case of the questions A, B, E, H, and I, the numerical value (1) of the first choice is selected as the answer. The numerical value, that is, answer result (1)<average value (3) of the answer field. Therefore, the CPU 1 corrects the numerical value of the choice using Formula (5) to derive a corrected answer result y. Specifically, the corrected numerical value y₁ of the numerical value (1) of the first choice is the following value.

y₁=1+(1.84-1)+0.4=2.24

In the case of the question C, the numerical value (2) of the second choice is selected as the answer. The magnitude relationship between the answer result and the average value of the answer field is the same as that in the case of the first choice. Therefore, the CPU 1 corrects the numerical value (2) of the second choice using Formula (5). Specifically, the corrected numerical value y₃ of the numerical value (2) of the second choice is the following value.

y₃=2+(1.84-1)+0.4=3.24

In the case of the question J, the numerical value (4) of the fourth choice is selected as the answer. The numerical value, that is, answer result (4)>average value (3) of the answer field. Therefore, the CPU 1 corrects the numerical value (4) of the fourth choice using Formula (3). Specifically, the corrected numerical value y₄ of the numerical value (4) of the fourth choice is the following value.

y₄=4−(1.84−1)+0.4=3.56

In the case of questions D, F, and G, the numerical value (5) of the fifth choice is selected as the answer. The magnitude relationship between the answer result and the average value of the answer field is the same as that in the case of the fourth choice. Therefore, the CPU 1 corrects the numerical value (5) of the fifth choice using Formula (3). Specifically, the corrected numerical value y₅ of the numerical value (5) of the fifth choice is the following value.

y₅=5−(1.84−1)+0.4=4.56

Although the third choice is not selected by on the respondent (Suzuki), the CPU 1 corrects the numerical value (3) of the third choice using Formula (4). If the option is selected, the answer result (3)=the average value (3) of the answer field. Therefore, the CPU 1 corrects the numerical value of the choice using Formula (4). Specifically, the corrected numerical value y₃ of the numerical value (3) of the third choice is the following value.

y₃=3+0.4=3.4

The CPU 1 calculates the corrected degree of deviation (σ_{correction}) using Formula (6).

$$\begin{matrix}[ Mathematical Formula 6 ] & \\ {σ}_{correction} = \sqrt{\frac{1}{n} {\sum }_{i = 1}^{n} {( {y}_{i} - \overline{x} - δ )}^{2}} & ( 6 )\end{matrix}$$

That is, the CPU 1 calculates the difference (the deviation) between the corrected numerical value (=3.4) of the median value (3) of the choices in the answer field and the corrected numerical value of the choice selected by the respondent (see “deviation from 3” in column (1)). The CPU 1 calculates the square value of the difference (see “square of (1)” in column (2)). Furthermore, the CPU 1 calculates the square root of the average value of the square values, and derives the degree of deviation (=1.04) from the average value of the answer field.

The CPU 1 calculates the corrected average value of the answers using Formula (7).

$$\begin{matrix}[ Mathematical Formula 7 ] & \\ {μ}^{*} = \sqrt{\frac{1}{n} {\sum }_{i = 1}^{n} {y}_{i}} & ( 7 )\end{matrix}$$

For example, in the example of FIGS. 14A and 14B, =3.17 (=(2.24+2.24+3.24+4.56+2.24+4.56+4.56+2.24+2.24+3.56)/10). Since corrected degree of deviation (=1.04)<degree of deviation before correction (1.84) is satisfied, a result in which variations are suppressed is obtained.

Note that the degree of deviation (σ_{current}) is not limited to that calculated by the method described above, and may be derived as follows. For example, the CPU 1 can calculate the average value of the differences between the maximum value and the minimum value of each of the answer results as the degree of deviation (σ_{current}) using Formula (8).

$$\begin{matrix}[ Mathematical Formula 8 ] & \\ {σ}_{curent} = \frac{{x}_{max} - {x}_{min}}{2} & ( 8 )\end{matrix}$$

xₘₐₓ denotes maximum value of answer result.
xₘᵢₙ denotes minimum value of answer result.

Alternatively, the CPU 1 can calculate, as the degree of deviation degree (σ_{correction}), the average value of the differences between the maximum value and the minimum value of each of the corrected answer results using Formula (9).

$$\begin{matrix}[ Mathematical Formula 9 ] & \\ {σ}_{correction} = \frac{{y}_{max} - {y}_{min}}{2} & ( 9 )\end{matrix}$$

yₘₐₓ denotes maximum value of corrected answer result.
yₘᵢₙ denotes minimum value of corrected answer result.

In still another aspect, the CPU 1 can calculate, as the degree of deviation (σ_{current}), the average value of the differences between the first quantile and the third quantile of each of the answer results using Formula (10).

$$\begin{matrix}[ Mathematical Formula 10 ] & \\ {σ}_{curent} = \frac{{Q}_{x 3} - {Q}_{x 1}}{2} & ( 10 )\end{matrix}$$

Qₓ₁ denotes first quantile of answer result.
Qₓ₃ denotes third quantile of answer result.

Alternatively, the CPU 1 can calculate, as the degree of deviation (σ_{correction}), the average value of the differences between the first quantile and the third quantile of each of the corrected answer results using Formula (11).

$$\begin{matrix}[ Mathematical Formula 11 ] & \\ {σ}_{correction} = \frac{{Q}_{y 3} - {Q}_{y 1}}{2} & ( 11 )\end{matrix}$$

Q_{y1} denotes first quantile of corrected answer result.
Q_{y3} denotes third quantile of corrected answer result.

<Case where Number of Choices is not Constant>

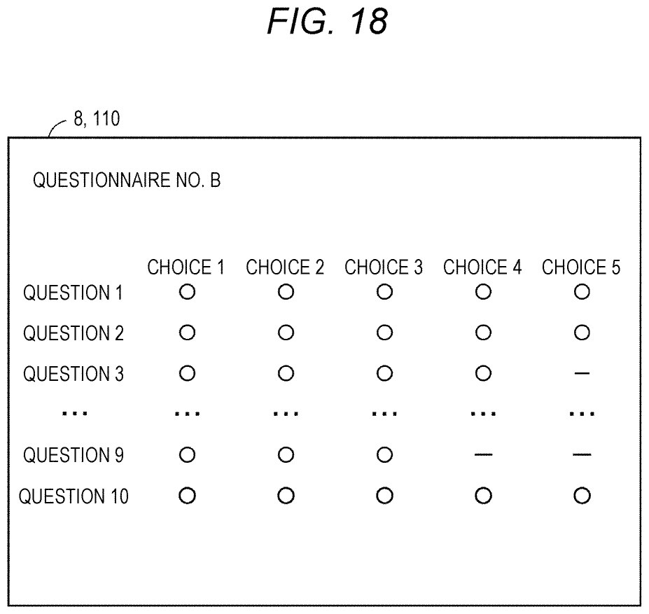

Note that the number of choices may varies from question to question depending on the content of the questionnaire Therefore, counting in a case where the number of choices varies t will be described with reference to FIG. 18. FIG. 18 is a diagram illustrating a screen of a questionnaire in which the number of choices varies depending on a question.

The monitor 8 displays a screen including a questionnaire Question 1 or question 2 has five choices as answers. On the other hand, question 3 has four choices. Question 9 has three choices.

In this case, the CPU 1 performs normalization to equalize the numerical values of the upper limits of the choices before performing the processing of correcting variations in answers, which has been described above. As an example, a case where the numerical value of the first choice is 1, the numerical value of the second choice is 2, the numerical value of the third choice is 3, the numerical value of the fourth choice is 4, and the numerical value of the fifth choice is 5 will be described.

In the example of FIG. 18, the CPU 1 corrects answers to questions with the number of choices different from the maximum value (=5) of the number of choices or the minimum value (=3) of the number of choices on the basis of either the maximum value or the minimum value.

For example, the CPU 1 performs processing of correcting the answers to question 3 and question 9 to the maximum value (=5). The number of choices for question 3 is 4, and the maximum value is 4. Therefore, the CPU 1 corrects the answer result to question 3 (the numerical value of the choice selected by the respondent) as follows. y=4/3x−1/3x

x denotes the answer result before correction. y denotes the corrected result.

On the other hand, the number of choices for question 9 is 3, and the maximum value is 3. Therefore, the CPU 1 corrects the answer result to question 9 as follows.

y=2x−1 In this manner, the CPU 1 makes the width (the maximum value) of the numerical values of the choices constant, and then performs the correction processing to correct variations in the answer results. As a result, even in the case of questionnaires with different numbers of choices, the CPU 1 can correct variations in answers.

As described above, the questionnaire count device 130 according to the present embodiment can present highly objective results to questions in a questionnaire while reducing the burden on respondents. Since the questionnaire count device 130 adopts the same calculation method in any pattern, it is not necessary to recognize a pattern in advance, and the results can be corrected without depending on the type of the pattern. In addition, since the questionnaire count device 130 makes a correction using the result of the questionnaire answered by the respondent at that time, it is possible to correct even a questionnaire that has no past results.

The technical features disclosed above can be summarized as follows.

[Configuration 1] According to an embodiment, a program to be executed by a computer (for example, the computer system 200) is provided. This program causing a processor (for example, the CPU 1) of the computer to perform accessing each of answer results in which an answer to each of a plurality of questions constituting a questionnaire is selected from a plurality of choices of a plurality of numerical values, calculating a variation in the answer results, and correcting each of the answer results on the basis of the variation calculated.

[Configuration 2] In another aspect, the accessing includes the CPU 1 accessing each of answer results (for example, numerical values of choices selected as answers) by each of a plurality of respondents, the answer results being stored in the hard disk 5. The program further causes the computer to perform, for each of the plurality of respondents, calculating a variation in the answer results, correcting the answer results on the basis of the variation calculated, and counting corrected answer results for each of the plurality of respondents. As a result, variations in the answer results of the individual respondents can be suppressed.

[Configuration 3] In another aspect, the accessing includes the CPU 1 accessing each of answer results of a same questionnaire answered at different times by a same respondent, the answer results being stored in the hard disk 5. The program causes the computer to perform, for each of the answer results by the same respondent, calculating and correcting and counting corrected answer results of the answers. As a result, it is possible to grasp the tendency of answers to the same question made at different timings by the same respondent.

[Configuration 4] In another aspect, the correcting includes correcting a value of a choice selected as an answer to each of the questions.

[Configuration 5] In another aspect, the variation includes a degree of deviation between a value of each of the choices selected as an answer and an average value of the plurality of numerical values.

[Configuration 6] In another aspect, the correcting includes correcting the answer result by using a difference between an average value of the answer results and an average value of the plurality of numerical values.

[Configuration 7] In another aspect, each of questions of the questionnaire includes a question with an ordinal scale or a Likert scale.

[Configuration 8] In another aspect, the number of questions in the questionnaire is equal to or larger than five.

[Configuration 9] In another aspect, the number of the choices is equal to or larger than four.

[Configuration 10] In another aspect, calculating the variation includes calculating, for questions with a same number of choices, a variation in answer results to the questions. For example, the CPU 1 can individually calculate variations in answers to a question having five choices and variations in answers to a question having four choices.

[Configuration 11] In still another aspect, the program causes the computer system 200 to, in a case where a number of choices is different for each question, equalize an upper limit of a question with a small upper limit of a numerical value of a choice to a largest numerical value of the upper limit of the choice to correct an answer result of the question with a small upper limit of the numerical value. Calculating the variation includes calculating the variation by using the corrected answer result instead of an answer result before correction for the question with a smaller upper limit of the numerical value. For example,

[Configuration 12] A method performed by a computer in order to correct a variation of a questionnaire result, the method including accessing, by the CPU 1, each of answer results in which an answer to each of a plurality of questions constituting a questionnaire is selected from a plurality of choices of a plurality of numerical values, calculating, by the CPU 1, a variation in the answer results, and correcting, by the CPU 1, each of the answer results on the basis of the variation calculated.

With such a configuration, for example, variations in answers obtained by a questionnaire performed online can be corrected, and thus a questionnaire using a portable terminal device such as a smartphone or a tablet terminal can be easily implemented.

[Configuration 13] The questionnaire count device 130 includes a memory (for example, the hard disk 5 or the RAM 4) storing the questionnaire correction program according to any one of the above, and a processor (CPU 1) for executing the program. As a result, the computer system 200 in which the program is installed can function as the questionnaire count device 130.

The disclosed technical features are applicable to an online questionnaire, a cloud-based questionnaire, and the like.

Although embodiments of the present invention have been described and illustrated in detail, the disclosed embodiments are made for purposes of illustration and example only and not limitation. The scope of the present invention should be interpreted by terms of the appended claims, and it is intended that meanings equivalent to the claims and all modifications within the scope are included.

What is claimed is:

1. A non-transitory recording medium storing a computer readable questionnaire correction program causing a computer to perform:
accessing each of answer results in which an answer to each of a plurality of questions constituting a questionnaire is selected from a plurality of choices of a plurality of numerical values;
calculating a variation in the answer results; and
correcting each of the answer results on a basis of the variation calculated.

2. The non-transitory recording medium storing a computer readable questionnaire correction program according to claim 1, wherein
the accessing includes accessing each of answer results by each of a plurality of respondents, and
the computer readable questionnaire correction program causing the computer to perform:
the calculating and the correcting for each of the plurality of respondents; and
counting corrected answer results for each of the plurality of respondents.

3. The non-transitory recording medium storing a computer readable questionnaire correction program according to claim 1, wherein
the accessing includes accessing each of answer results of a same questionnaire answered at different times by a same respondent, and
the computer readable questionnaire correction program causing the computer to perform:
for each of the answer results by the same respondent, the calculating and the correcting; and
counting corrected answer results of the answers.

4. The non-transitory recording medium storing a computer readable questionnaire correction program according to claim 1, wherein the correcting includes correcting a value of a choice selected as an answer to each of the questions.

5. The non-transitory recording medium storing a computer readable questionnaire correction program according to claim 1, wherein the variation includes a degree of deviation between a value of each of the choices selected as an answer and an average value of the plurality of numerical values.

6. The non-transitory recording medium storing a computer readable questionnaire correction program according to claim 1, wherein the correcting includes correcting the answer result by using a difference between an average value of the answer results and an average value of the plurality of numerical values.

7. The non-transitory recording medium storing a computer readable questionnaire correction program according to claim 1, wherein each of questions of the questionnaire includes a question with an ordinal scale or a Likert scale.

8. The non-transitory recording medium storing a computer readable questionnaire correction program according to claim 1, wherein a number of questions in the questionnaire is equal to or larger than five.

9. The non-transitory recording medium storing a computer readable questionnaire correction program according to claim 1, wherein a number of the choices is equal to or larger than four.

10. The non-transitory recording medium storing a computer readable questionnaire correction program according to claim 1, wherein calculating the variation includes calculating, for questions with a same number of choices, a variation in answer results to the questions.

11. The non-transitory recording medium storing a computer readable questionnaire correction program according to claim 1, wherein
the computer readable questionnaire correction program causes the computer to, in a case where a number of choices is different for each question, equalize an upper limit of a question with a small upper limit of a numerical value of a choice to a largest numerical value of the upper limit of the choice to correct an answer result of the question with a small upper limit of the numerical value, and
calculating the variation includes calculating the variation by using the corrected answer result instead of an answer result before correction for the question with a smaller upper limit of the numerical value.

12. A method performed by a computer in order to correct a questionnaire result, the method comprising:
accessing each of answer results in which an answer to each of a plurality of questions constituting a questionnaire is selected from a plurality of choices of a plurality of numerical values;
calculating a variation in the answer results; and
correcting each of the answer results on a basis of the variation calculated.

13. A questionnaire count device comprising:
a memory that stores the computer readable questionnaire correction program according to claim 1; and
a hardware processor that executes the computer readable questionnaire correction program.
